(19) United States
(12) Patent Application Publication
(10) Pub. No.: US 2019/0387507 A1
(43) Pub. Date: Dec. 19, 2019

(54) USER EQUIPMENT APPARATUS, BASE STATION, SIGNAL RECEPTION METHOD, AND SIGNAL TRANSMISSION METHOD

(71) Applicant: NTT DOCOMO, INC., Tokyo (JP)

(72) Inventors: Kazuaki Takeda, Tokyo (JP); Kazuki Takeda, Tokyo (JP); Satoshi Nagata, Tokyo (JP)

(73) Assignee: NTT DOCOMO, INC., Tokyo (JP)

(21) Appl. No.: 16/480,795

(22) PCT Filed: Jan. 22, 2018
(86) PCT No.: PCT/JP2018/001757

§ 371 Date: Jul. 25, 2019

(30) Foreign Application Priority Data
Feb. 3, 2017 (JP) 2017-019115

(51) Int. Cl. H04W 72/04; H04W 28/06; H04L 27/32; H04L 5/14

(52) U.S. Cl. CPC H04W 72/042; H04W 28/06; H04L 5/1438; H04W 72/0453; H04L 27/32

(57) ABSTRACT

A user equipment apparatus includes a signal reception unit configured to receive, from a base station, a signal including a plurality of code words, each formed by one or more code blocks in one carrier; and a received signal processing unit configured to process the signal including the plurality of code words. A user equipment apparatus also includes a transmission signal processing unit configured to encode information to be transmitted to a base station to generate one or more code blocks, and to generate a signal including a plurality of code words, each formed by the one or more code blocks; and a signal transmission unit configured to transmit the signal including the plurality of code words in one carrier.

### TECHNICAL FIELD

The present invention relates to a user equipment apparatus, a base station, a signal reception method, and a signal transmission method.

### BACKGROUND ART

In Long Term Evolution (LTE) and LTE-Advanced, a 20 MHz bandwidth called a “component carrier” is used for communication between a base station (gNB: enhanced Node B) and a user equipment apparatus (UE: user equipment). Both information to be transmitted in an uplink from the user equipment apparatus to the base station and information to be transmitted in a downlink from the base station to the user equipment apparatus are encoded in coding units called “code words (CWs)”, each having a size corresponding to a transport block size (TBS) (see Non-Patent Document 1). For this reason, a peak data rate in the uplink and the downlink is theoretically determined by a maximum TBS, i.e., a maximum CW size.

### PRIOR ART DOCUMENT

### Non-Patent Document

[Non-Patent Document 1] 3GPP TS 36.212 V14.1.1 (2017-01)

### DISCLOSURE OF INVENTION

### Problem(s) to be Solved by the Invention

In the 3rd Generation Partnership Project (3GPP), a next-generation system called 5G, which follows LTE and LTE-Advanced, is currently under discussion.

In a next-generation system, it is expected that a higher frequency band will be used. In this case, it is also expected that a bandwidth, such as 400 MHz, 800 MHz, 1 GHz, or the like, which is wider than 20 MHz will be reserved for one carrier. However, a user equipment apparatus does not always use such a wider bandwidth. For example, when a bandwidth of one carrier is 800 MHz, and a CW size or a TB size corresponding to 400 MHz is determined according to a capability of a user equipment apparatus, a peak data rate is limited according to the maximum CW size. It should be noted that the CW size may be determined not only from the viewpoint of the capability of the user equipment apparatus, but also from the viewpoint of a support capability of a base station. In either case, the peak data rate is limited according to the maximum CW size.

It is an object of the present invention to provide a mechanism to increase a peak data rate independently of a CW size.

### Means for Solving the Problem(s)

In one aspect of the present invention, there is provision for a user equipment apparatus, including:

a signal reception unit configured to receive, from a base station, a signal including a plurality of code words, each formed by one or more code blocks in one carrier; and

a received signal processing unit configured to process the signal including the plurality of code words.

### Advantageous Effect of the Invention

According to the present invention, it is possible to increase a peak data rate independently of a CW size.

### BRIEF DESCRIPTION OF THE DRAWINGS

FIG. 1 is a diagram illustrating an exemplary configuration of a radio communication system according to an embodiment of the present invention.

FIG. 2A is a diagram illustrating a single carrier operation.

FIG. 2B is a diagram illustrating a multi-carrier operation.

FIG. 3A is a diagram illustrating an exemplary bandwidth structure in a radio communication system according to an embodiment of the present invention.

FIG. 3B is a diagram illustrating relationships between a band of a radio communication system and RF bands of a base station and a user equipment apparatus according to an embodiment of the present invention.

FIG. 4 is a sequence diagram illustrating a communication procedure in a radio communication system according to an embodiment of the present invention.

FIG. 5A is a diagram illustrating DCI used in an embodiment of the present invention an example where sets of DCI with the same amount of information are generated).

FIG. 5B is a diagram illustrating DCI used in an embodiment of the present invention (an example where part of information is removed).

FIG. 6A is a conceptual diagram illustrating an example where DCI is continuously transmitted in a PDCCH search space.

FIG. 6B is a conceptual diagram illustrating an example where DCI is discontinuously transmitted in a PDCCH search space.

FIG. 7A is a diagram illustrating an exemplary structure of a CB subband determined in relation to a location of an NR PSS/SSS/PBCH (an example where an NR PSS/SSS/PBCH is placed at a boundary of two CB subbands).

FIG. 7B is a diagram illustrating an exemplary structure of a CB subband determined in relation to a location of an NR PSS/SSS/PBCH (an example where an NR PSS/SSS/PBCH is placed within one CB subband).

FIG. 8A is a diagram illustrating first exemplary placement of an NR PSS/SSS/PBCH (an example where an NR PSS/SSS/PBCH is placed in one location).

FIG. 8B is a diagram illustrating first exemplary placement of an NR PSS/SSS/PBCH (an example where NR PSS/SSS/PBCHs are placed in a plurality of locations).

FIG. 9 is a diagram illustrating second exemplary placement of an NR PSS/SSS/PBCH.

FIG. 10 is a block diagram illustrating a functional configuration of Cl transmitter according to an embodiment of the present invention.

FIG. 11 is a block diagram illustrating a functional configuration of a receiver according to an embodiment of the present invention.

FIG. 12 is an exemplary hardware configuration of a transmitter or a receiver according to an embodiment of the present invention.

### DETAILED DESCRIPTION OF THE PREFERRED EMBODIMENTS

Hereinafter, embodiments of the invention will be described with reference to the accompanying drawings. The embodiments described below are merely examples and embodiments of the invention are not limited to the following embodiments. While the embodiments are described using the terms defined in LTE, for example, the invention is not limited to LTE but can be also applied to another system. In the specification and the appended claims, “LTE” is used in a broad meaning including not only a communication system corresponding to Release 8 or 9 of 3GPP but also a communication system corresponding to Release 10, 11, 12, or 13 of 3GPP and a fifth-generation communication system corresponding to Release 14 or later of 3GPP.

### System Configuration

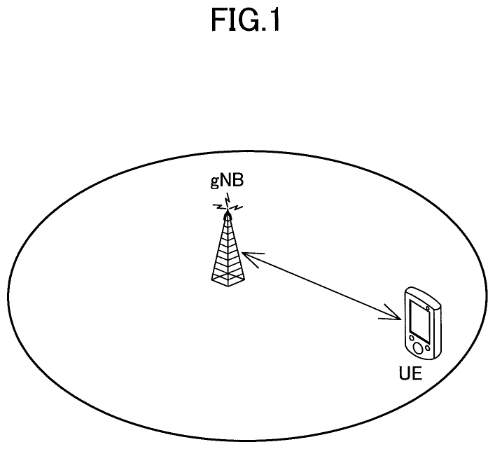

FIG. 1 is a conceptual diagram of an exemplary configuration of a radio communication system according to an embodiment of the present invention. As illustrated in FIG. 1, the radio communication system according to the embodiment of the present invention includes a base station gNB and a user equipment apparatus UE. While a single base station gNB and a single user equipment apparatus UE are illustrated in FIG. 1, a plurality of base stations gNBs or a plurality of user equipment apparatuses UEs may be included.

The base station gNB can accommodate one or more (for example, three) cells (also referred to as “sectors”). When the base station gNB accommodates a plurality or cells, the entire coverage area of the base station gNB can be divided into a plurality of small areas, and in each small area, a communication service can be provided through a base station subsystem (for example, a small indoor base station remote radio head (RRH)). The term “cell” or “sector” refers to a part or whole of the coverage area in which the base station and/or the base station subsystem provides a communication service. Further, the terms “base station”, “gNB”, “cell”, and “sector” can be used interchangeably in this specification. In some cases, the base station gNB is also referred to as a fixed station, a NodeB, an eNodeB (eNB), an access point, a femto cell, a small cell, a transmission reception point (TRP), or the like.

In some cases, the user equipment apparatus UE is referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or any other suitable term by those skilled in the art.

The base station gNB and the user equipment apparatus UE communicate with each other in a downlink (DL) and an uplink (UL) using a predetermined band. In a next-generation communication system, a bandwidth such as 400 MHz, 800 MHz, 1 GHz, or the like may be used as a carrier bandwidth. Further, a plurality of carriers may be simultaneously used between the base station gNB and the user equipment apparatus UE. Communication using one carrier is referred to as a “single carrier operation” and communication simultaneously using a plurality of carriers is referred to as a multi-carrier operation.

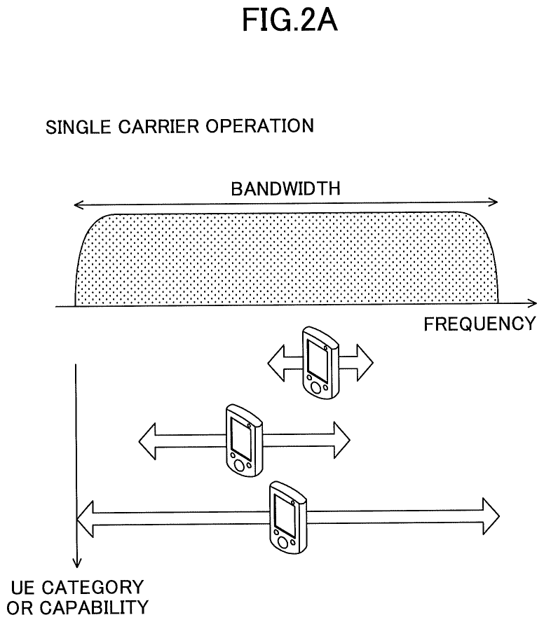

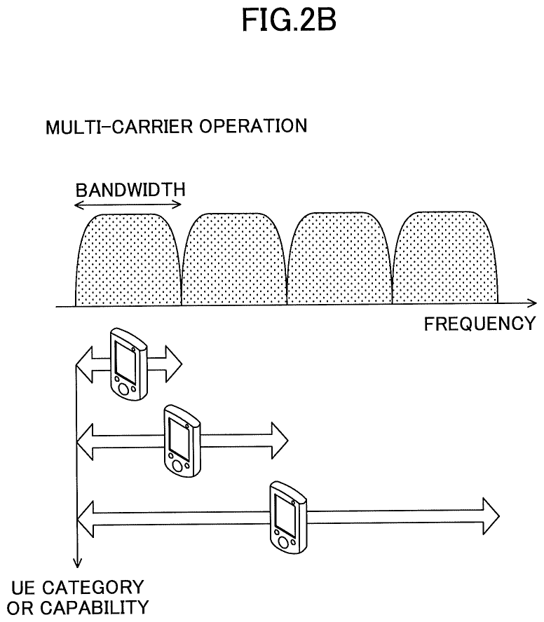

FIGS. 2A and 2B are diagrams illustrating a single carrier operation and a multi-carrier operation, respectively. As illustrated in FIG. 2A, according to the single carrier operation, the whole bandwidth reserved for one carrier or a portion thereof may be used by the user equipment apparatus UE. Alternatively, the user equipment apparatus UE may transmit or receive a wideband signal using a plurality of RF devices. The bandwidth used by the user equipment apparatus UE may be determined based on a category, a capability, or the like of the user equipment apparatus US.

As illustrated. in FIG. 2B, according to the multi-carrier operation, a plurality of carriers are simultaneously used. All reserved carriers or a portion thereof may be used by the user equipment apparatus UE. The number of carriers used by the user equipment apparatus UE may be determined based on a category, a capability, or the like of the user equipment apparatus UE.

Next, channels and signals used between the user equipment apparatus UE and the base station gNB are described below.

First, typical signals used for downlink communication are described.

The user equipment apparatus UE needs to perform cell search to communicate with the base station gNB. Signals used for cell search are referred to as synchronization signals (SSs), which include a primary synchronization signal (PSS) typically used for synchronization of symbol timing and detection of a local ID and a secondary synchronization signal (SSS) typically used for synchronization of a radio frame and detection of a cell group ID.

Basic information which the user equipment apparatus UE is required to read after cell search is referred to broadcast information, which includes a master information block (MIB) including a system bandwidth, a system frame number, and so on, and a system information block (SIB) including other kinds of system information. The MIB may be transmitted on a physical broadcast channel (PBCH) and the SIB may be transmitted. on a physical downlink shared channel (PDSCH).

The user equipment apparatus UE receives downlink control information (DCI) on a downlink control channel placed. in a predetermined band. The downlink control channel may be referred to as a physical downlink control channel (PDCCH), an enhanced physical downlink control channel (ePDCCH), b or an NR-PDCCH.

The user equipment apparatus UE also receives downlink data on a downlink shared channel (downlink data channel) placed in a predetermined band. The downlink shared channel may be referred to as a PDSCH (physical downlink shared channel) or an NR-PDSCH.

Second, typical signals used for uplink communication are described.

The user equipment apparatus UE transmits uplink data on an uplink shared channel (uplink data channel) placed in a predetermined band. The uplink shared channel may be referred to as a physical uplink shared channel (PUSCH) or an NR-PUSCH.

The user equipment apparatus US transmits a scheduling request (SR) to request the base station gNB to schedule an uplink data channel. The SR is transmitted on a physical uplink control channel (PUCCH). When a resource block assignment is provided via an UL grant by the base station eNB in response to the SR, the user equipment apparatus UE can transmit data. In addition to the SR, an ACK/NACK response to downlink data, quality information, or the like is transmitted on the PUCCH.

These charnels and signals are examples in LTE and may be differently termed.

### Bandwidth Structure

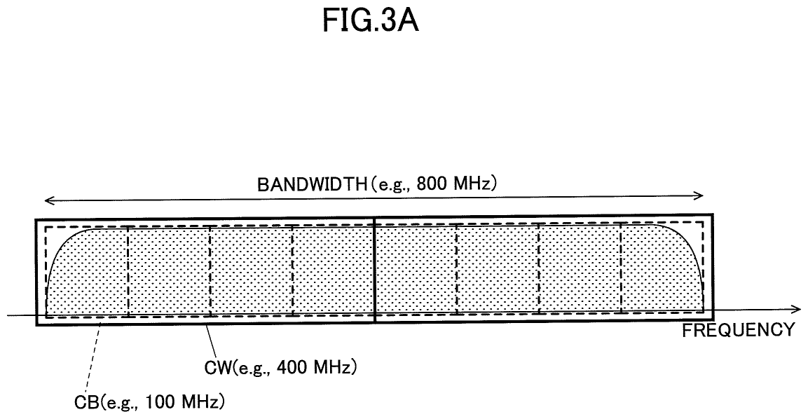

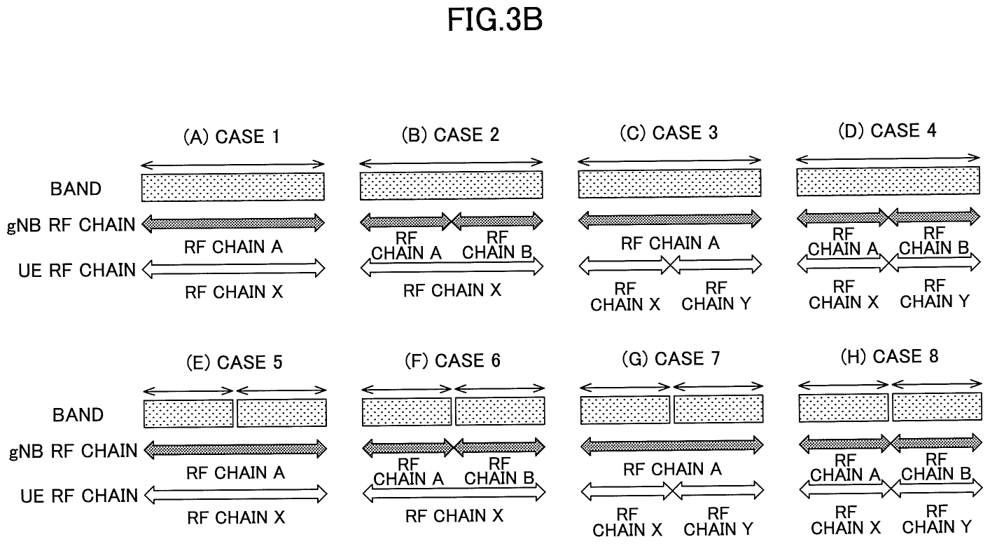

A structure of a bandwidth in which these channels and signals are transmitted is described in detail. FIG. 3A is a diagram illustrating an exemplary bandwidth structure in a radio communication system according to an embodiment of the present invention.

As described above, in a next-generation communication system, a bandwidth such as 400 MHz, 800 MHz, 1 GHz, or the like may be used as a carrier bandwidth. FIG. 3A illustrates an example where a bandwidth of 800 MHz is used. A coding unit having a bandwidth narrower than the carrier bandwidth may be determined. The coding unit is a unit used by the base station gNB and the user equipment apparatus UE to encode information bits and hereinafter is referred to as a code block (CB). The bandwidth occupied by one CB is referred to as a CB subband. Encoding efficiency can be improved by increasing the coding unit. On the other hand, an appropriate CB subband should be determined in consideration of retransmission efficiency, because retransmission is also performed in units of CBs. FIG. 3A illustrates an example where a coding unit of 100 MHz is used.

Further, information is transmitted between the base station gNB and the user equipment apparatus UE in units of code words (CWs), each having a size corresponding to a TBS specified by a higher layer. A CW is formed by one or more CBs. The bandwidth occupied by one CW is referred to as a CW size. FIG. 3A illustrates an example where a CW is formed by four CBs (in other words, a CW size is equal to 400 MHz). As described above, a CW that is an information transmission unit and a CB that is a coding unit are separately defined. Further, a peak data rate can be increased by transmitting a signal including a plurality of CWs at the same timing.

The bandwidth, the CB subband, and the CW size illustrated in FIG. 3A are merely examples and any other values may be used. Further, two or more different CB subbands and two or more different CW sizes may be used in one carrier bandwidth.

A band of the radio communication system and RF bands of the base station gNB and the user equipment apparatus UE may be selectively determined. FIG. 3B is a diagram illustrating relationships between the band of the radio communication system and the RF bands of the base station gNB and the user equipment apparatus UE. FIG. 3B(A) illustrates an example where the band of the radio communication system is continuous, a single RF band is used in the base station gNB, and a single RF band is used in the user equipment apparatus UE. FIG. 3B (B) illustrates an example where the band of the radio communication system is continuous, a plurality of RF bands are used in the base station gNB, and a single RF band is used in the user equipment apparatus UE. FIG. 3B (C) illustrates an example where the band of the radio communication system is continuous, a single RF band is used in the base station gNB, and a plurality of RF bands are used in the user equipment apparatus UE. FIG. 3B (D) illustrates an example where the band of the radio communication system is continuous, a plurality of RF bands are used in the base station gNB, and a plurality of RF bands are used in the user equipment apparatus UE. FIGS. 3B(E)-3B(H) are the same as FIGS. 3B(A)-3B(D), except that the band of the radio communication system is discontinuous. The bandwidth structure of the radio communication system as described with reference to FIG. 3A can be applied to any of FIGS. 3B(A)-3B(H).

### Communication Procedure in Radio Communication System

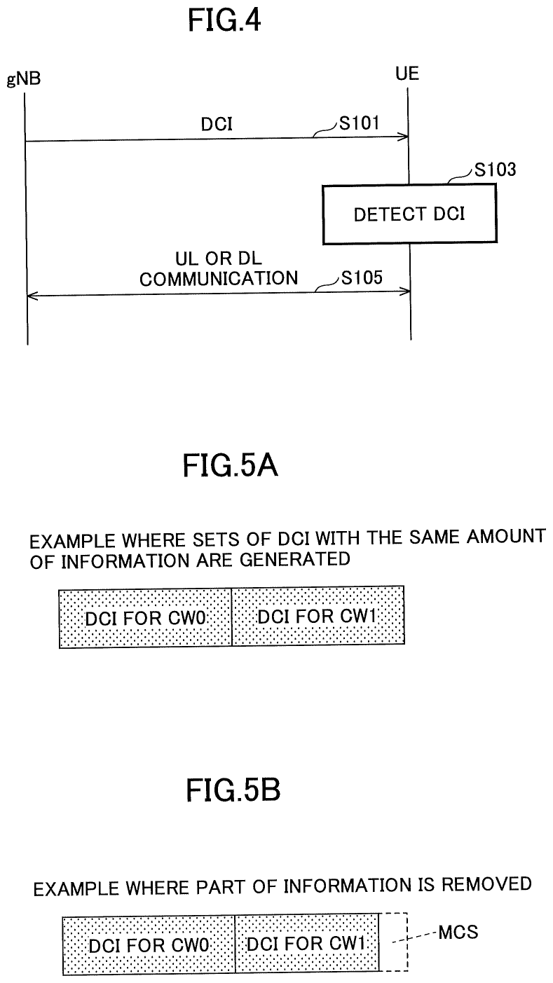

Next, a communication procedure in a radio communication system in which a signal including a plurality of CWs is transmitted at the same timing is described below. FIG. 4 is a sequence diagram illustrating a communication procedure in a radio communication system according to an embodiment of the present invention. In the following description, identification information is used to identify each of the plurality of CWs transmitted in one carrier. A CW index is used as an example of identification information for identifying a CW. For example, when two CWs are transmitted as illustrated in FIG. 3A, the CWs are identified by CW indexes CW0 and CW1, respectively.

The base station gNB generates DCI for each CW and transmits the DCI to the user equipment apparatus UE. The user equipment apparatus UE receives the DCI generated for each CW (S101). The DCI includes a CW index, resource assignment information (resource location) generated by scheduling in the base station gNB for the user equipment apparatus UE, a modulation and coding scheme (MCS), precoder information, or the like. The DCI may further include the number of CWs, that is, the number of CWs for which the DCI is generated in a search space in which the user equipment apparatus UE detects the DCI.

FIGS. 5A and 5B are diagrams illustrating DCI used in an embodiment of the present invention. As illustrated in FIG. 5A, DCI with the same amount of information may be generated for each CW. In other words, each DCI may include a CW index, resource assignment information, an MCS, precoder information, or the like. While a CW index and resource assignment information vary among CWs, an MCS, precoder information, or the like may be used in common among CWs. Thus, common information (redundant information) such as an MCS may be removed, as illustrated in FIG. 5B. Then, a cyclic redundancy check (CRC) may be individually added to each DCI, which may be then scrambled using a Radio Network Temporary ID (RNTI) that is an identifier of the user equipment apparatus UE. The RNTI of the user equipment apparatus UE may either be used in common among a plurality of CWs or be individually defined for each CW.

While FIGS. 5A and 5B illustrate examples where DCI is individually generated for each of CWs, DCI for a plurality of CWs may be collectively generated. In other words, the collectively-generated DCI may include a plurality of CW indexes for identifying the plurality of CWs and resource assignment information, a MCS, precoder information, or the like for the plurality or CWs. A CRC is added to the collectively-generated DCI, which is then scrambled using the RNTI of the user equipment apparatus UE.

The DCI is transmitted in a predetermined region called a PDCCH search space. The PDCCH search space is a space for detecting DCI, which is determined by substituting a Radio Network Temporary ID (RNTI) of the user equipment apparatus UE and a subframe number into a hash function predetermined by both the base station gNB and the user equipment apparatus UE. The PDCCH search space is used to reduce processing for detecting DCI in the user equipment apparatus UE.

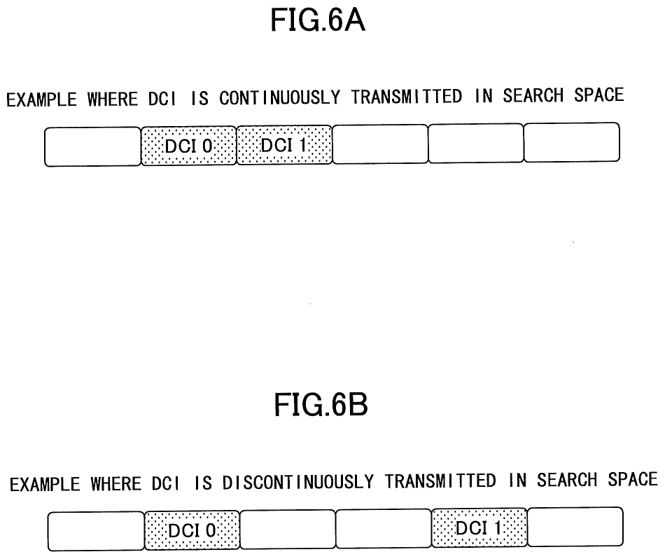

FIGS. 6A and 6B are conceptual diagrams illustrating examples where DCI is transmitted in a PDCCH search space. As illustrated in FIG. 6A, DCI may be continuously placed in the PDCCH search space. Alternatively, as illustrated in FIG. 6B, DCI may be discontinuously placed in the PDCCH search space. In either case, DCI may be placed in order of CW index.

In order to facilitate the user equipment apparatus UE to detect DCI, sets of DCI may be continuously placed in the PDCCH search space. For example, for a user located at a cell edge, a larger amount of DCI may be placed in the PDCCH search space compared to a user located at the center of a cell. Since a plurality of CWs are transmitted in one carrier according to an embodiment of the present invention, a range where DCI is placed may be expanded. The range where DCI is placed may be determined in advance, or may be provided by means of radio resource control (RRC) signaling or the like from the base station gNB to the user equipment apparatus UE. Alternatively, regardless of whether a plurality of CWs are transmitted in one carrier, the range where DCI is placed may not be expanded.

The user equipment apparatus UE detects, in a PDCCH search space, whether DCI for the user equipment apparatus UE is transmitted (S103). The user equipment apparatus UE determines the PDCCH search space by substituting the RNTI of the user equipment apparatus UE and a sub frame number into the hash function predetermined by both the base station gNB and the user equipment apparatus UE. When sets of DCI are continuously placed in the PDCCH search space as illustrated in FIG. 6A, the user equipment apparatus UE can continuously detect the sets of DCI in the PDCCH search space. For example, the user equipment apparatus UE tries to sequentially detect DCI in the PDCCH search space. When DCI placed in the first location can be detected and the number of CWs can be determined from the detected DCI, the user equipment apparatus UE can continuously detect all the sets of DCI. When sets of DCI are discontinuously placed in the PDCCH search space as illustrated in FIG. 6B, the user equipment apparatus UE tries to sequentially detect the sets of DCI in the PDCCH search space. When common information such as an MCS is removed as illustrated in FIG. 5B, the user equipment apparatus UE compensates for the removed information using another set of DCI.

Then, the base station gNB and the user equipment apparatus UE perform uplink communication or downlink communication according to the DCI (S105). For downlink communication, the base station gNB transmits a signal including a plurality of CWs to the user equipment apparatus UE according to the DCI, and then the user equipment apparatus UE receives the signal including the plurality of CWs according to the DCI and processes the signal. For uplink communication, the user equipment apparatus UE transmits a signal including a plurality of CWs to the base station gNB according to the DCI, and then the base station gNB receives the signal including the plurality of CWs according to the DCI and processes the signal.

### Exemplary Placement of PSS, SSS, and PBCH

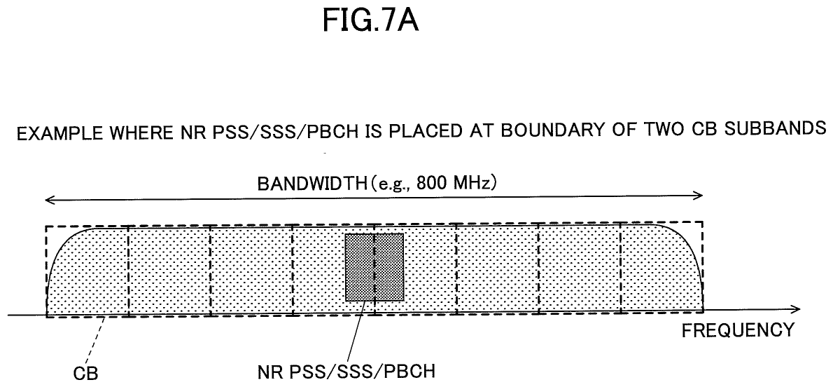

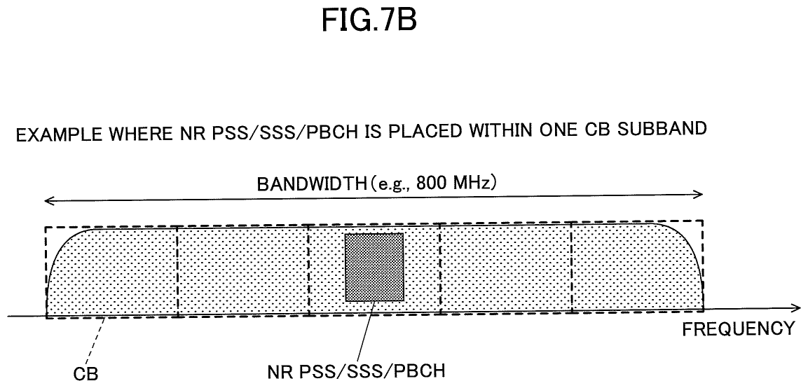

With reference to FIGS. 7A and 7B, exemplary structures of a CB sup band determined in relation to a location of an NR PSS/SSS/PBCH are described below.

As described above, the user equipment apparatus UE is required to initially read a PSS, an SSS, and a PBCH (hereinafter referred to as an “NR PSS/SSS/PBCH”) in order to communicate with the base station gNB. It is expected that the NR PSS/SSS/PBCH will be placed at a predetermined location such as a center frequency of a carrier.

When a CW size and a CB subband are determined as illustrated in FIG. 3A, and then an NR PSS/SSS/PBCH is placed at a center frequency of a carrier, the NR PSS/SSS/PBCH is consequently placed at a boundary of two CWs and two CBs, as illustrated in FIG. 7A. In this case, the user equipment apparatus UE needs to receive and process the two CWs and the two CBs to obtain the NR PSS/SSS/PBCH. In order to simplify reception processing in the user equipment apparatus UE, the NR PSS/SSS/PBCH may be placed within one CB subband. Since the user equipment apparatus UE needs to receive a SIB transmitted on a PDSCH after receiving a MIB transmitted in the PBCH, it is preferable that the user equipment apparatus UE receive the NIB and the SIB within the same RF band, from the viewpoint of a workload of the user equipment apparatus UE. When the NR PSS/SSS/PBCH is placed within one CB subband, it is highly likely that the user equipment apparatus UK can receive the MIB and the SIB within the same RF band.

FIG. 7B is a diagram illustrating an example where an NR PSS/SSS/PBCH is placed within one CB subband. For example, when the NR PSS/SSS/PBCH is placed at a center frequency of carrier, the carrier bandwidth may be divided into an odd number of CB subbands, and then the NR PSS/SSS/PBCH may be placed in the center CB subband.

Since a CW is formed by one or more CBs, in the example illustrated in FIG. 7B, the two CB subbands on the left side may be determined as one CW, the center CB subband may be determined as one CW, and the two CB subbands on the right side may be determined one CW.

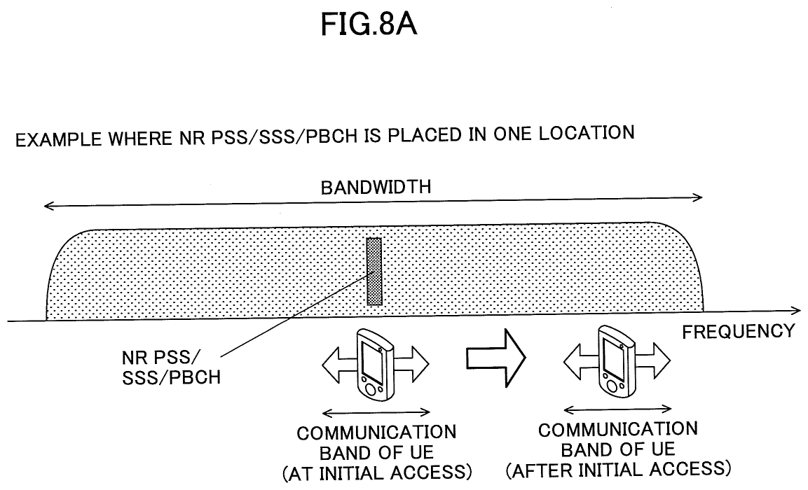

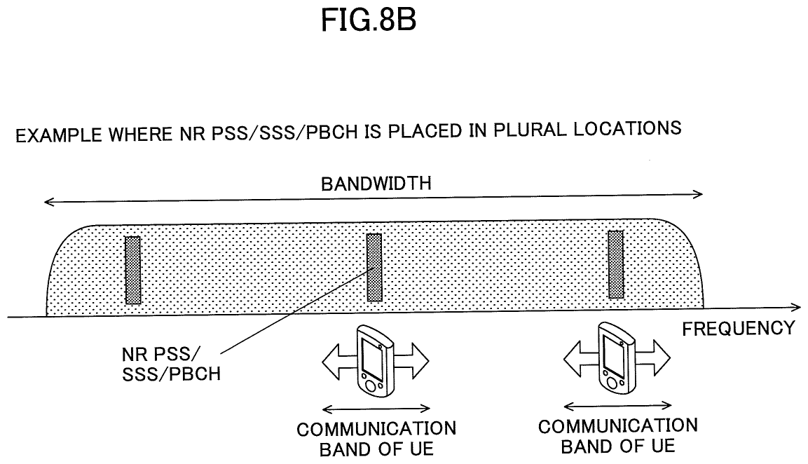

In a radio communication system according to an embodiment of the present invention, the number of locations where an NR PSS/SSS/PBCH is placed in the carrier bandwidth is not limited to one. FIGS. 8A and 8B illustrate exemplary placement of an NR PSS/SSS/PBCH. FIG. 8A illustrates an example where an NR PSS/SSS/PBCH is placed in one location. In this example, the user equipment apparatus UE may communicate in the band where the NR PSS/SSS/PBCH is placed at initial access, and then communicate in another band after the initial access. FIG. 8B illustrates an example where NR PSS/SSS/PBCHs are placed in a plurality of locations. In this example, the user equipment apparatus UE may communicate in a band where any of the NR PSS/SSS/PBCHs is placed. In this example, it is also possible that the user equipment apparatus UE communicates in the band where the NR PSS/SSS/PBCH is placed at initial access, and then communicates in another band after the initial access.

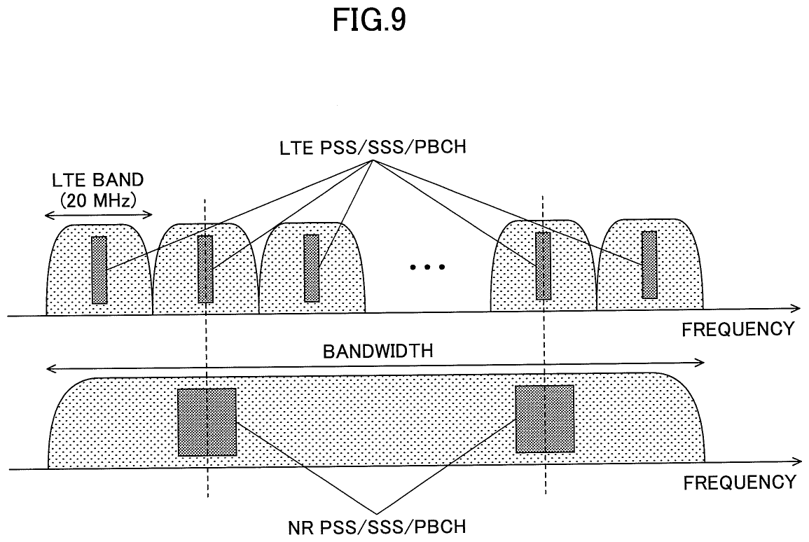

In a radio communication system according to an embodiment of the present invention, an NR PSS/SSS/PBCH may be placed in the carrier bandwidth based on a PSS/SSS/PBCH in another system. FIG. 9 is a diagram illustrating exemplary placement of an NR PSS/SSS/PBCH. For example, it is assumed that another radio access technology (RAT) such as an LTE system can be used in the same frequency band. In this case, a location of the NR PSS/SSS/PBCH in the radio communication system according to this embodiment may overlap with a location of a PSS/SSS/PBCH in the other RAT.

### Configuration of Transmitter

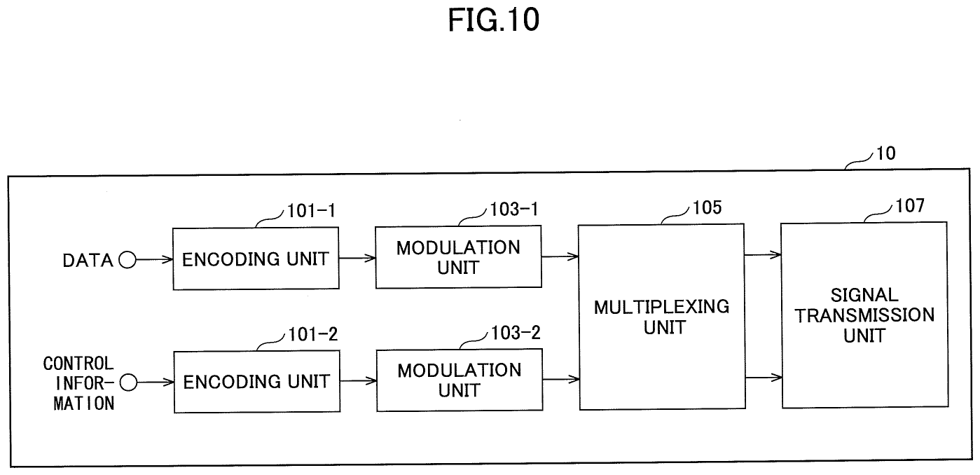

FIG. 10 is a block diagram illustrating a functional configuration of a transmitter 10 according to an embodiment of the present invention. The transmitter 10 may be included in the base station gNB or the user equipment apparatus UE. The transmitter 10 includes encoding units 101-1 and 101-2, modulation units 103-1 and 103-2, a multiplexing unit 105, and a signal transmission lint 107. The names of these functional units in FIG. 10 are merely examples, and these functional units may be differently termed. For example, the encoding units 101-1 and 101-2, the modulation units 103-1 and 103-2, and the multiplexing unit 105 may be collectively referred to as a transmission signal processing unit.

Assuming that the transmitter 10 is included in the base station gNB, that is, assuming downlink communication, each functional unit of the transmitter 10 is described below.

When data to be transmitted to the user equipment apparatus UE is received from an upper node or the like and input to the encoding unit 101-1, the encoding unit 101-1 encodes the data in units of CBs. The modulation unit 103-1 modulates the encoded data according to a modulation scheme determined for the user equipment apparatus UE.

When DCI to be transmitted to the user equipment apparatus UTE is generated by a control information generation unit (not illustrated) and input to the encoding unit 101-2, the encoding unit 101-2 encodes the DCI. The modulation unit 103-2 modulates the encoded DCI according to a predetermined modulation scheme.

The multiplexing unit 105 determines a CW size according to a TBS specified by a higher layer, generates a CW from one or more CWs after encoding and modulation, and multiplexes the CW into a resource assignment location determined by scheduling. The multiplexing unit 105 also multiplexes the DCI after encoding and modulation into a resource location in a PDCCH search space.

The signal transmission unit 107 transforms a multiplexed signal into a time domain signal by means of inverse fast Fourier transform (IFFT), inserts a cyclic prefix (CP) into the signal, performs D/A conversion or the like, and. then transmits the signal to the user equipment apparatus UE.

Assuming that the transmitter 10 is included in the user equipment apparatus UE, that is, assuming uplink communication, each functional unit of the transmitter 10 is described below.

When data to be transmitted to the base station gNB is input to the encoding unit 101-1, the encoding unit 101 encodes the data in units of CBs. The modulation unit 103-1 modulates the encoded. data according to a modulation scheme indicated by DCI received from the base station gNB.

When control information to be transmitted to the base station gNB is input to the encoding unit 101-2, the encoding unit 101-2 encodes the control information. The modulation unit 103-2 modulates the encoded control information according to a predetermined modulation scheme.

The multiplexing unit 105 determines a CW size according to a TBS specified by a higher layer, generates a CW from one or more CWs after encoding and modulation, and multiplexes the CW into a resource assignment location indicated by DCI. The multiplexing unit 105 also multiplexes the control information after encoding and modulation into a resource location reserved for a PUCCH.

The signal transmission unit 107 transforms a multiplexed signal into a time domain signal by means of IFFT, inserts a CP into the signal, performs D/A conversion or the like, and then transmits the signal to the base station gNB.

### Configuration of Receiver

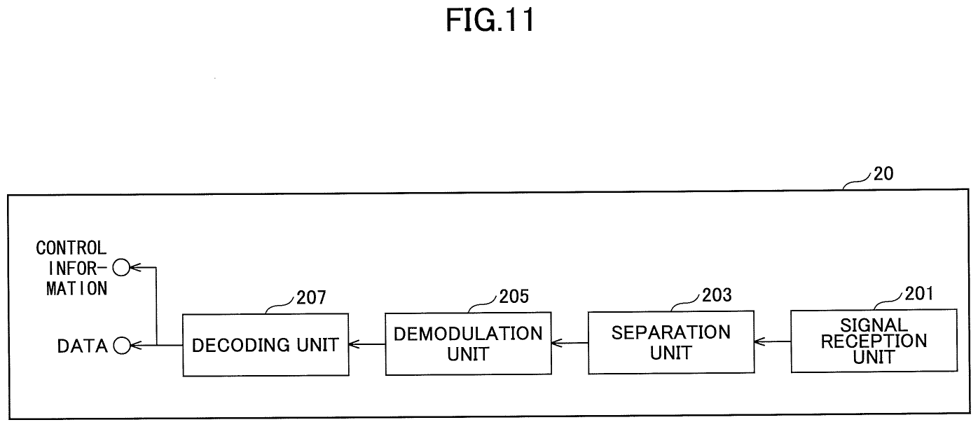

FIG. 11 is a block diagram illustrating a functional configuration of a receiver 20 according to an embodiment of the present invention. The receiver 20 may be included in the base station gNB or the user equipment apparatus UE. The receiver 20 includes a signal reception unit 201, a separation unit 203, a demodulation unit 205, and a decoding unit 207. The names of these functional units in FIG. 11 are merely examples, and these functional units may be differently termed. For example, the separating unit 203, the demodulation unit 205, and the decoding unit 207 may be collectively referred to as a received signal processing unit.

Assuming that the receiver 20 is included in the user equipment apparatus UE, that is, assuming downlink communication, each functional unit of the receiver 20 is described below.

The signal reception unit 201 performs A/D conversion or the like on a signal received from the base station gNB, removes a CP from the signal, and obtains a frequency domain signal by means of fast Fourier transform (FFT).

The separation unit 203 separates data for the user equipment apparatus UE, DCI, another signal, or the like from the frequency domain signal based on a channel estimation value or the like. The data for the user equipment apparatus US are included in a plurality of CWs, each formed by one or more CWs.

For the DCI, the demodulation unit 205 demodulates the DCI according to a predetermined modulation scheme. For the data, the demodulation unit 205 demodulates the data according to the DCI. The decoding unit 207 decodes the demodulated data and the demodulated DCI.

Assuming that the receiver 20 is included in the base station gNB, that is, assuming uplink communication, each functional unit of the receiver 20 is described below.

The signal reception unit 201 performs A/D conversion or the like on a signal received from the user equipment apparatus UE, removes a CP from the signal, and obtains a frequency domain signal by means of FFT.

The separation unit 203 separates data for the base station gNB, control information, another signal, or the like from. the frequency domain signal based on a channel estimation value or the like. The data for the base station gNB are included in a plurality of CUs, each formed by one or more CUs.

For the control information, the demodulation unit 205 demodulates the control information accord ng to a predetermined. modulation scheme. For the data, the demodulation unit 205 demodulates the data according to the DCI determined in advance by the base station gNB. The decoding unit 207 decodes the demodulated data and the demodulated control information.

### Hardware Configuration

The block diagrams used to describe the above-mentioned embodiment illustrate blocks of functional units. The functional blocks (components) are implemented by an arbitrary combination of hardware and/or software. A means for implementing each functional block is not particularly limited. That is, each functional block may be implemented by one apparatus in which a plurality of elements are physically and/or logically coupled or by a plurality of apparatuses that are physically and/or logically separated from each other and are connected directly and/or indirectly (for example, in a wired manner and/or wirelessly).

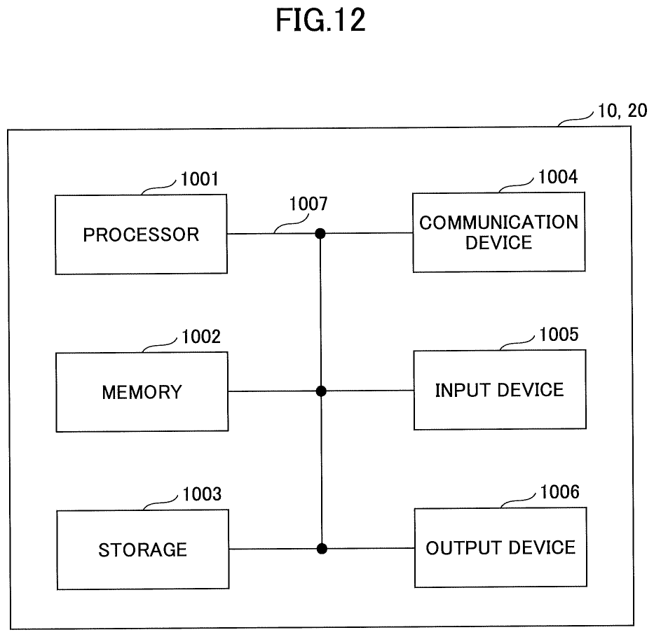

For example, the transmitter 10, the receiver 20, or the like according to the embodiment of the invention may function as a computer that performs a signal reception method and a signal transmission method according to this embodiment. FIG. 12 is a diagram illustrating an example of a hardware configuration of the transmitter 10 or the receiver 20 according to this embodiment. Each of the transmitter 10 and the receiver 20 may be physically configured as a computer device including, for example, a processor 1001, a memory 1002, a storage 1003, a communication device 1004, an input device 1005, an output device 1006, and a bus 1007.

In the following description, the term “device” can be substituted with, for example, a circuit, an apparatus, or a unit. The hardware configuration of the transmitter 10 or the receiver 20 may include one or a plurality of devices illustrated in FIG. 12 or may not include some of the devices.

Each function of the transmitter 10 and the receiver 20 may be implemented by the following process: predetermined software (program) is read onto hardware such as the processor 1001 or the memory 1002, and the processor 1001 performs an operation to control the communication of the communication device 1004 and the reading and/or writing of data from and/or to the memory 1002 and the storage 1003.

The processor 1001 operates, for example, an operating system to control the overall operation of the computer. The processor 1001 may be a central processing unit (CPU) including, for example, an interface with peripheral devices, a control device, an arithmetic device, and a register. For example, the encoding units 101-1 and 101-2, the modulation units 103-1 and 103-2, the multiplexing unit 105, the separation unit 203, the demodulation unit 205, and the decoding unit 207, and so on may be implemented in the processor 1001.

The processor 1001 reads a program (program code), a software module, and/or data from the storage 1003 and/or the communication device 1004 to the memory 1002 and performs various types of processes according to the program, the software module, or the data. A program that causes a computer to perform at least some of the operations described in the embodiment may be used. For example, the encoding units 101-1 and 101-2 in the transmitter 10 may be implemented by a control program that is stored in the memory 1002 and is executed by the processor 1001. The other functional blocks may be similarly implemented. In the embodiment, the above-mentioned various processes are performed by one processor 1001. However, the processes may be simultaneously or sequentially performed by two or more processors 1001. The processor 1001 may be mounted on one or more chips. The program may be transmitted over the network through a telecommunication line.

The memory 1002 is a computer-readable recording, medium and may include, for example, at least one of a read only memory (ROM), an erasable programmable ROM (EPROM), electrically erasable programmable ROM (EEPROM), and a random access memory (RAM). The memory 1002 may be also referred to as, for example, a register, a cache, or a main memory (main storage device). The memory 1002 can store, for example, an executable program (program code) and a software module that can perform a signal reception method and a signal transmission method according to the embodiment of the invention.

The storage 1003 is a computer-readable recording medium and may include, for example, at least one of an optical disk such as a compact disc RPM (CD-ROM), a hard disk drive, a flexible disk, a magneto-optical disk (for example, a compact disc, a digital versatile disc, or a Blu-ray (registered trademark) disc), a smart card, a flash memory (for example, a card, a stick, or a key drive), a floppy (registered trademark) disk, and a magnetic strip. The storage 1003 may be also referred to as an auxiliary storage device. The above-mentioned storage medium may be, for example, a database, a server, and other suitable media including the memory 1002 and/or the storage 1003.

The communication device 1004 is hardware (a transmission and reception device) for communicating with a computer through a wired and/or wireless network and is also referred to as, for example, a network device, a network controller, a network card, or a communication module. For example, the signal transmission unit 107, the signal reception unit 201, and the like may be implemented by the communication device 1004.

The input device 1005 is an input unit (for example, a keyboard, a mouse, a microphone, a switch, a button, or a sensor) that receives an input from the outside. The output device 1006 is an output unit (for example, a display, a speaker, or an LED lamp) that performs an output process to the outside. The input device 1005 and the output device 1006 may be integrated into a single device (for example, a touch panel).

Devices such as the processor 1001 and/or the memory 1002 are connected to each other via the bus 1007 for information communication. The bus 1007 may be a single bus or the devices may be connected to each other by different buses.

Each of the transmitter 10 and the receiver 20 may include hardware such as a microprocessor, a digital signal processor (DSP), an application specific integrated circuit (ASIC), a programmable logic device (PLD), and a field programmable gate array (FPGA). Some or all of the functional blocks may be implemented by the hardware. For example, the processor 1001 may be implemented by at least one of these hardware components.

### Effects of Embodiments

According to an embodiment of the present invention, it is possible to increase a peak data rate independently of a CW size. For example, even if a maximum CW size is determined by a specification, a peak data rate is not limited by the maximum CW size.

When a signal including a plurality of CWs is transmitted, DCT is needed for each of the CWs. By continuously placing the DCI, detection processing in the user equipment apparatus UE can be simplified. Further, by removing information (redundant information) in DCI which is common to a plurality of CWs, the amount of signaling between the base station gNB and the user equipment apparatus UE can be reduced.

Further, by defining a CB that is an encoding unit different from a CW, encoding and retransmission can be performed in units smaller than the CW size, and thus retransmission efficiency can be improved.

Further, by placing a PSS/SSS/PBCH within one CE subband, and/or by overlapping the PSS/SSS/PBCH with a PSS/SSS/PBCH in another RAT, reception processing in the user equipment apparatus UE can be simplified.

### Supplementary Explanation

Each aspect/embodiment described in the specification may be applied to systems using Long Term Evolution (LTE), LIE-Advanced (LTE-A) , SUPER 3G, IMT-Advanced, 4G, 5G, Future Radio Access (FRA), W-CDMA (registered trademark), GSM (registered trademark) , CDMA2000, Ultra Mobile Broadband (UMB), IEEE 802.11 (Wi-Fi), IEEE 802.16 (WiMAX), IEEE 802.20, Ultra-WideBand (UWB), Bluetooth (registered trademark), and other suitable systems and/or next-generation systems that have functionality enhanced based on these systems.

The terms “system.” and “network” used in the specification. are interchangeably used.

In the specification, a specific operation performed by the base station may be performed by an upper node of the base station. In a network having one or a plurality of network nodes including the base station, it is clearly understood that various operations performed for communication with the user equipment apparatus can be performed by the base station and/or a network node (for example, including an MME or an S-GW without limitation) other than the base station. The number of network nodes other than the base station is not limited to one, and a plurality of other network nodes (for example, an MME and an S-GW) may be combined with each other.

Information or the like can be output from a higher layer (or a lower layer) to a lower layer (or a higher layer). Information or the like may be input or output via a plurality of network nodes.

The input or output information or the like may be stored in a specific location (for example, a memory) or may be managed in a management table. The input or output information or the like may be overwritten, updated, or edited. The output information or the like may be deleted. The input information or the like may be transmitted to another apparatus.

The transmission of information is not limited to the aspects/embodiments described in the specification and may be performed by other means. For example, the transmission of information may be performed by physical layer signaling (for example, downlink control information (DCI) or uplink control information (UCI)), higher layer signaling (for example, radio resource control (RRC) signaling, medium access control (MAC) signaling, or broadcast information (a master information block (MIB) and a system information block (SIB))), another signal, or a combination thereof. The RRC signaling may be also referred to as an RRC message and may be, for example, an RRC connection setup message or an RRC connection reconfiguration message.

Determination may be made based. on a value (0 or 1) represented by 1 bit may be made based on a true or false value (boolean: true or false), or may be made based on comparison with a numerical value (for example, comparison with a predetermined value).

Regardless of the fact that software is referred to as software, firmware, middleware, a microcode, a hardware description language, or another name, the software is broadly interpreted to include an instruction, an instruction set, a code, a code segment, a program code, a program, a sub-program, a software module, an application, a software application, a software package, a routine, a subroutine, an object, an executable file, an execution thread, a procedure, a function, or like.

Software, an instruction, or the like may be transmitted or received via a transmission medium. For example, when software is transmitted from a website, a server, or another remote source using a wired technology such as a coaxial cable, an optical cable, a twisted pair, and a digital subscriber line (DSL) and/or a wireless technology such as an infrared ray, radio, and microwaves, the wired technology and/or the wireless technology is included in the definition of a transmission medium.

The information, the signal, and the like described the specification may be represented using any of various technologies. For example, the data, the instruction, the command, the information, the signal, the bit, the symbol, the chip, and the like mentioned throughout the description may be represented by a voltage, a current, an electromagnetic wave, a magnetic field, or a magnetic particle, an optical field or a photon, or any combination thereof.

The terms described in the specification and/or terms necessary to understand the specification may be replaced with terms that have same or similar meanings. For example, a channel and/or a symbol may be a signal. A signal may be a message. A component carrier (CC) may be referred to as a carrier frequency, a cell, or the like.

The information, the parameter, or the like described in the specification may be represented by an absolute value, may be represented by a relative value from a predetermined value, or may be represented by another piece of corresponding information. For example, a radio resource may be indicated using an index.

The names used for the above-described parameters are not limited in any respect. Further, a numerical expression or the like in which the parameters are used can be different from the numerical expression disclosed explicitly in the specification. Since various channels (for example, a PUCCH and a PDCCH) and information elements (for example, TPC) can be identified with any suitable names, various names allocated to the various channels and the information elements are not limited in any respect.

The terms “determining” and “deciding” used in the specification include various operations. The terms “determining” and “deciding” can include, for example, “determination” and “decision” for calculating, computing, processing, deriving, investigating, looking-up (for example, looking-up in a table, a database, or another data structure), and ascertaining operations. In addition, the terms “determining” and “deciding” can include “determination” and “decision” for receiving (for example, information reception), transmitting (for example, information transmission), input, output, and accessing (for example, accessing data in a memory) operations. The terms “determining” and “deciding” can include “determination” and “decision” for resolving, selecting, choosing, establishing, and comparing operations. That is, the terms “determining” and “deciding” can include “determination” and “decision” for any operation.

The term “based on” used in the specification does not mean “only based on” unless otherwise stated. In other words, the term “based on” means both “only based on” and “at least based on”.

When reference is made to elements in which terms “first,” “second,” and the like are used in the specification, the number or the order of the elements is not generally limited. These terms can be used in the specification as a method to conveniently distinguish two or more elements from each other. Accordingly, reference to first and second elements does not imply that only two elements are employed or the first element is prior to the second element in some ways.

The terms “include” and “including” and the modifications thereof are intended to be inclusive, similarly to the term “comprising”, as long as they are used in the specification or the claims. In addition, the term “or” used in the specification or the claims does not mean exclusive

In each aspect/embodiment described in the specification, for example, the order of the processes in the procedure, the sequence, and the flowchart may be changed unless a contradiction arises. For example, for the method described in the specification, elements of various steps are presented in the exemplified order. However, the invention is not limited to the presented specific order.

The aspects/embodiments described. in the specification may be individually used, may be combined, or may be switched during execution. In addition, transmission of predetermined information (for example, transmission of “being X”) is not limited to being performed explicitly, but may be performed implicitly (for example, the transmission of the predetermined information is not performed).

The invention has been described in detail above. It will be apparent to those skilled in the art that the invention is not limited to the embodiments described in the specification. Various modifications and changes can. be made, without departing from. the scope and spirit of the invention described in the claims. Therefore, the embodiments described in the specification are illustrative and do not limit the invention.

The present international application is based on and claims the benefit of priority of Japanese Patent Application No. 2017-019115 filed on Feb. 3, 2017, the entire contents of which are hereby incorporated by reference.

### DESCRIPTION OF NOTATIONS

gNB base station
UE user equipment apparatus
10 transmitter
101-1, 101-2 encoding unit
103-1, 103-2 modulation unit
105 multiplexing unit
107 signal transmission unit
20 receiver
201 signal reception unit
203 separation unit
205 demodulation unit
207 decoding unit
1001 processor
1002 memory
1003 storage
1004 communication device
1005 input unit
1006 output unit
1007 bus

1. A user equipment apparatus, comprising: a signal reception unit configured to receive, from a base station, a signal including a plurality of code words, each formed by one or more code blocks in one carrier; and
a received signal processing unit configured to process the signal including the plurality of code words.

2. The user equipment apparatus as claimed in claim 1,
wherein the signal reception unit receives downlink control information generated for each of the plurality of code words, and
the received signal processing unit processes the signal including the plurality of code words according to the downlink control information.

3. The user equipment apparatus as claimed in claim 2,
wherein the downlink control information includes identification information for identifying each of the plurality of code words, and is transmitted in a search space which is derived based on a function predetermined between the base station and the user equipment apparatus, and
the received signal processing unit detects the downlink control information in the search space.

4. The user equipment apparatus as claimed in claim 2,
wherein the downlink control information includes the number of code words included in the plurality of code words, and is continuously transmitted in a search space which is derived based on a function predetermined between the base station and the user equipment apparatus, and
the received signal processing unit continuously detects the downlink control information in the search space.

5. A user equipment apparatus, comprising:
a transmission signal processing unit configured to encode information to be transmitted to a base station to generate one or more code blocks, and to generate a signal including a plurality of code words, each formed by the one or more code blocks; and
a signal transmission unit configured to transmit the signal including the plurality of code words in one carrier.

6. A signal reception method in a user equipment apparatus, comprising the steps of:
receiving, from a base station, a signal including a plurality of code words, each formed by one or more code blocks in one carrier; and
processing the signal including the plurality of code words.

7. A signal transmission method in a user equipment apparatus, comprising the steps of:
encoding information. to be transmitted to a base station to generate one or more code blocks, and generating a signal including a plurality of code words, each formed by the one or more code blocks; and
transmitting the signal including the plurality of code words is one carrier.
